(19) United States
(12) Patent Application Publication
(10) Pub. No.: US 2013/0088309 A1
(43) Pub. Date: Apr. 11, 2013

(54) RING RESONATOR AND FILTER HAVING THE SAME

(71) Applicant: Jung-Woo BAIK, Seoul (KR)

(72) Inventor: Jung-Woo BAIK, Seoul (KR)

(73) Assignee: Electronics and Telecommunications Research Institute, Daejeon (KR)

(21) Appl. No.: 13/584,461

(22) Filed: Aug. 13, 2012

(30) Foreign Application Priority Data
Oct. 7, 2011 (KR) 10-2011-0102645

(51) Int. Cl. H01P 1/203; H01P 7/08

(52) U.S. Cl. 333/204; 333/219

(57) ABSTRACT

Disclosed are a resonator configured by a microstrip line and a filter. A ring resonator in accordance with an embodiment of the present invention includes a ring resonant unit configured by a microstrip line; and a via connecting the resonant unit with a ground surface. In accordance with the embodiment of the present invention, the ring resonator configured by a microstrip line including a via and a filter, thereby providing a smaller and cheaper resonator and filter.

### CROSS-REFERENCE TO RELATED APPLICATIONS

The present application claims priority of Korean Patent Application No. 10-2011-0102645, filed on Oct. 7, 2011, which is incorporated herein by reference in its entirety.

### BACKGROUND OF THE INVENTION

1. Field of the Invention

Exemplary embodiments of the present invention relate to a resonator configured by a microstrip line and a filter having the same, and more particularly, to a ring resonator configured by a microstrip line including a via and a filter having the same.

2. Description of Related Art

Communication devices such as mobile communication terminals include a filter for selectively transmitting and receiving signals. In designing a very high frequency filter, a dielectric resonator having high relative permittivity is used or filters are configured in a multi-stage form so as to obtain sharp skirt characteristics. The skirt characteristics mean characteristics determining whether division of a frequency pass band that passes through the filter and a frequency stop band that does not pass through the filter is sharp.

However, the dielectric resonator used to obtain the sharp skirt characteristics may be expensive and when a plurality of filters are configured in a multi-stage form, a physical size of the filter may be large.

In order to overcome the shortcomings, a resonator configured by microstrip line has been used. In this case, the microstrip line is formed in a ring and thus, has a smaller physical size. However, as the use of the mobile communication terminals is becoming popular and the size of the terminal is small, a demand for a filter having a smaller and cheaper resonator than a ring resonator configured by a prevalently used microstrip line has been increased.

### SUMMARY OF THE INVENTION

An embodiment of the present invention is directed to a smaller and cheaper resonator and a filter having the same by reducing a resonance mode frequency using a ring resonator configured by a microstrip line including a via and a filter having the same.

The foregoing and other objects, features, aspects and advantages of the present invention will be understood and become more apparent from the following detailed description of the present invention. Also, it can be easily understood that the objects and advantages of the present invention can be realized by the units and combinations thereof recited in the claims.

An embodiment of the present invention includes a ring resonant unit configured by a microstrip line and a via connecting a resonant unit with a ground surface.

In addition, another embodiment of the present invention includes a plurality of ring resonators including a ring resonant unit configured by a microstrip line and a via connecting a resonant unit with a ground surface, wherein the plurality of ring resonators are connected with each other in cascade.

### BRIEF DESCRIPTION OF THE DRAWINGS

FIG. 1 is a perspective view of a ring resonator in accordance with an embodiment of the present invention.

FIG. 2 is a plan view of a ring resonator in accordance with another embodiment of the present invention.

FIG. 3 is a diagram illustrating a frequency response of a ring resonator in accordance with another embodiment of the present invention.

FIG. 4 is a plan view of the ring resonator in accordance with the embodiment of the present invention.

FIG. 5 is a diagram illustrating a frequency response of the ring resonator in accordance with the embodiment of the present invention.

FIG. 6 is a diagram illustrating ideal response characteristics in a complex S-plane of the ring resonator filter to be designed in accordance with the embodiment of the present invention.

FIG. 7 is a diagram illustrating a resonator connection form of the ring resonator filter in accordance with the embodiment of the present invention.

FIG. 8 is a plan view of a ring resonator filter in accordance with another embodiment of the present invention.

FIG. 9 is a diagram illustrating a frequency response of a ring resonator filter in accordance with another embodiment of the present invention.

FIG. 10 is a plan view of the ring resonator filter in accordance with the embodiment of the present invention.

FIG. 11 is a diagram illustrating the frequency response of the ring resonator filter in accordance with the embodiment of the present invention.

FIG. 12 is a plan view of a ring resonator filter in accordance with another embodiment of the present invention.

FIG. 13 is a diagram illustrating a frequency response of the ring resonator filter in accordance with another embodiment of the present invention.

### DESCRIPTION OF SPECIFIC EMBODIMENTS

The above-mentioned objects, features, and advantages will be described in detail with reference to the accompanying drawings. Therefore, exemplary embodiments will be described in detail with reference to the accompanying drawings so that they can be easily practiced by those skilled in the art to which the present invention pertains. Further, when it is determined that the detailed description of the known art related to the present invention may obscure the gist of the present invention, the detailed description thereof will be omitted. Hereinafter, preferred embodiments of the present invention will be described in detail with reference to the accompanying drawings. In the drawings, like reference numerals denote like or similar functions in various aspects.

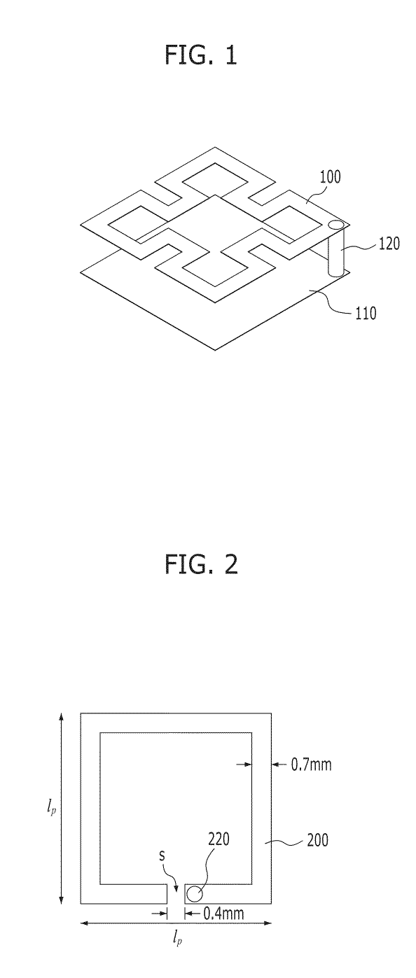

FIG. 1 is a perspective view of a ring resonator in accordance with an embodiment of the present invention.

Referring to FIG. 1, a ring resonator includes a ring resonant unit 100 configured by a microstrip line and a via 120 connecting the ring resonant unit 100 with a ground surface 110. A frequency is adjusted by forming the microstrip line in a ring, for example, a square, thereby generating resonance. In this case, the ring is not limited to a square. The via 120 is formed in a via hole of the resonant unit 100 and is connected with the ground surface 110, such that the resonant unit 100 may be connected with the ground surface 110 in parallel. As a result of forming the via 120 in the resonant unit 100, a resonance mode number n of the resonant unit 100 may be 0.5. The resonance mode number may be defined by n=lt/λg in the relation between a total circumferential length lt of the resonant unit and an intra-substrate wavelength λg. In this case, λg is inversely proportional to a central frequency. Therefore, when the resonance mode number n is 0.5 by forming the via 120 and λg is unchanged, lt=0.5×λg, such that the total circumferential length it of the resonant unit may be reduced half. In addition, the resonant unit 100 may be formed to have a structure folded toward the inside of the ring while maintaining the ring The resonant unit 100 formed to have the folded structure occupies a narrower area while performing the same function as the resonant unit formed to have an unfolded structure, thereby reducing the size of the resonator having the resonant unit 100.

FIG. 2 is a plan view of a ring resonator in accordance with another embodiment of the present invention.

Referring to FIG. 2, the ring resonator includes a ring resonant unit 200 configured by the microstrip line and a via 220 connecting a resonant unit 200 with a ground surface (not illustrated). The microstrip line is formed in a ring having a constant width, for example, a width of 0.7 mm. In this case, the resonant unit 200 may be formed in, for example, a square, a circle, but is not limited thereto. As described above, the resonator can be miniaturized by including the via 220.

Meanwhile, a part of the ring resonant unit 200 may have a opened (slit, s) form. For example, a part of the ring resonant unit 200 formed in a square is opened (s) by a width of 0.4 mm. As a result of opening (s) a part of the resonant unit 200, the resonance mode number n of the resonant unit 200 may be 0.5. As described above, when the resonance mode number n is 0.5, lt=0.5×λg and therefore, the total circumferential length lt of the resonant unit may be reduced half. Therefore, a part of the resonant unit 200 is opened (s) and therefore, the resonant including the resonant unit 200 can be miniaturized.

Meanwhile, forming the via 220 and partially opening (s) the resonant unit 200 each adjust the resonance mode number n to 0.5 and therefore, as illustrated in FIG. 2, when both of the via and the resonant unit are formed in a single resonator, the size of the resonator may be 75% smaller than that of the resonator, if not.

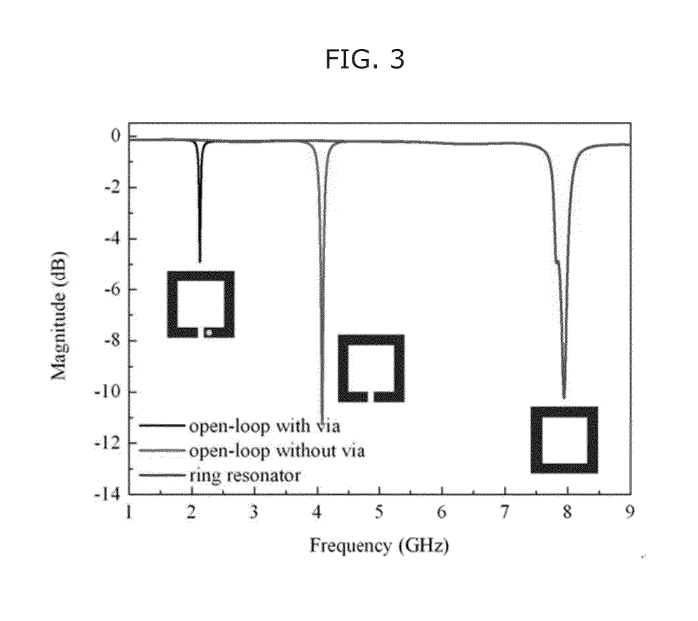

FIG. 3 is a diagram illustrating a frequency response of a ring resonator in accordance with another embodiment of the present invention.

Referring to FIG. 3, as the embodiment, according to the simulation results in which the resonant unit is designed to include the via having a diameter of 0.4 mm and a length lp=4.52 mm of a side of the resonating unit 200 formed in a square in FIG. 2, the resonant frequency of the ring resonator configured by the microstrip line is 8 GHz, the resonant frequency of the ring resonator configured by the microstrip line having a partially opened form is 4 GHz, and the resonant frequency of the ring resonator configured by the microstrip line including the via and having the partially opened form is 2 GHz. That I, the resonant frequency may be reduced to 50% by partially opening (s) the resonant unit 200 and the resonant frequency may be reduced to 75% by partially opening the resonant unit 200 and forming the via 220.

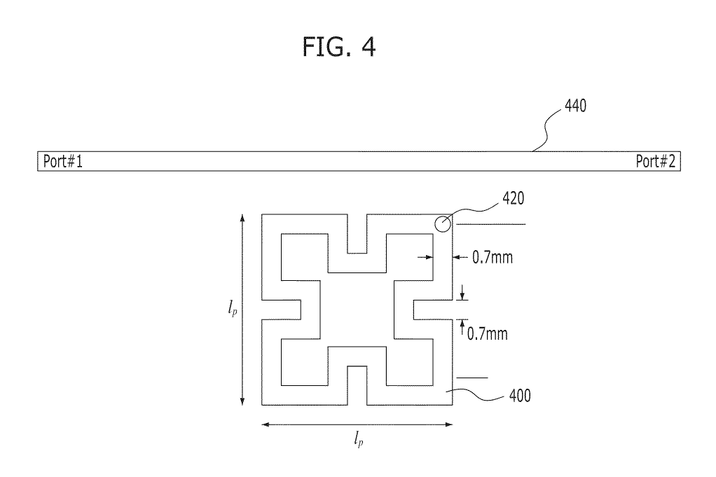

FIG. 4 is a plan view of the ring resonator in accordance with the embodiment of the present invention.

Referring to FIG. 4, a ring resonator 400 configured by the microstrip line is formed to have a folded structure toward the inside of the ring so as to reduce the size thereof and the resonance mode number may be adjusted to 0.5 by forming a via 420 connecting the resonant unit 400 with the ground surface (not illustrated). In this case, the resonator may be used as the ring resonator by a couple feeding type in which the resonant unit 400 is coupled with a feeding line 440. When the resonance mode number is 0.5, the total circumferential length of the resonator is reduced half than that of the resonator in which the resonance mode number is 1. However, a length may be slightly increased due to leakage field when considering a fringing effect appearing at an edge portion of the microstrip line.

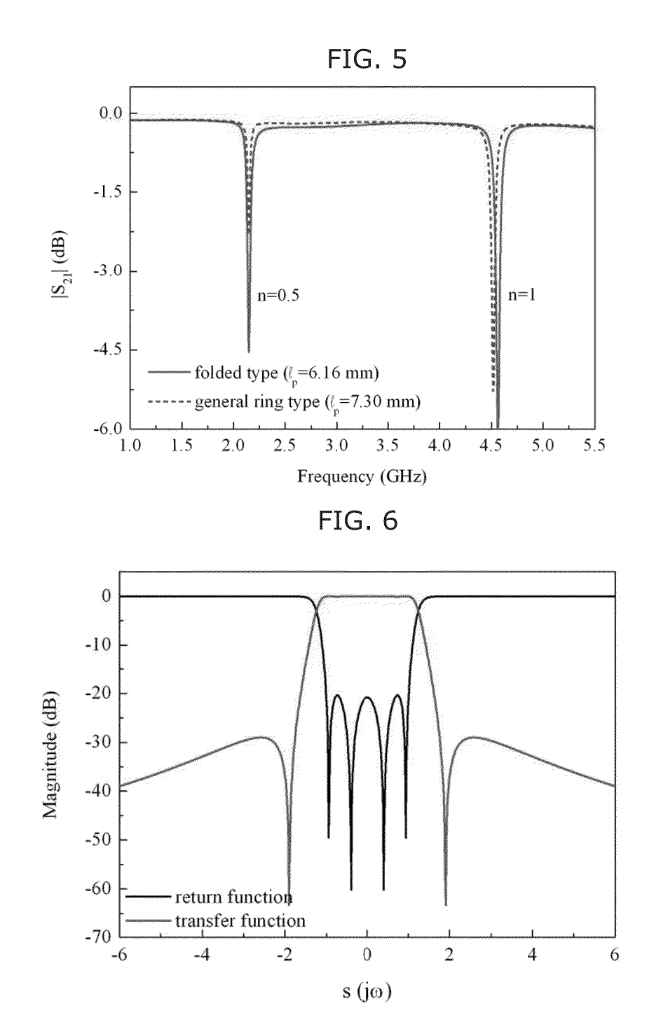

FIG. 5 is a diagram illustrating a frequency response of the ring resonator in accordance with the embodiment of the present invention.

Referring to FIG. 5, as the an embodiment, as a result of the simulation result of designing a diameter of the via as 0.4 mm, when the central frequency is a resonator of 4.562 GHz at the basic resonant mode n=1, a response in which the central frequency is 2.150 GHz at a forced resonant mode n=0.5 by a via may be additionally generated. In this case, the total circumferential length of the ring resonator is the same as a half wavelength of the central frequency and thus, n=0.5 and the size may be reduced to about 50%. In addition, the size is reduced to about 15.6% due to the folded structure and as a result, the size of the resonator may be reduced to 57.8% in total.

FIG. 6 is a diagram illustrating ideal response characteristics of the ring resonator to be designed in accordance with the embodiment of the present invention.

Referring to FIG. 6, two zero points (SZ) of response characteristics are each set to have a value of SZ=±j1.90 and four pole points (SP) within a bandwidth are each set to have values of SP=±j0.940 and SP=±j0.405. A characteristic function R(s), a transfer function t(s), a return function ρ(s) of the filter to be designed based thereon will be as follows.

$$R ( s ) = \frac{{s}^{4} + 1.04676 {s}^{2} + 0.1449}{{s}^{2} + 3.61}$$

$$ρ ( s ) = \frac{{s}^{4} + 1.04676 {s}^{2} + 0.1449}{{s}^{4} + 2.1513 {s}^{3} + 3.3617 {s}^{2} + 2.9973 s + 1.5872} ( s = j ω )$$

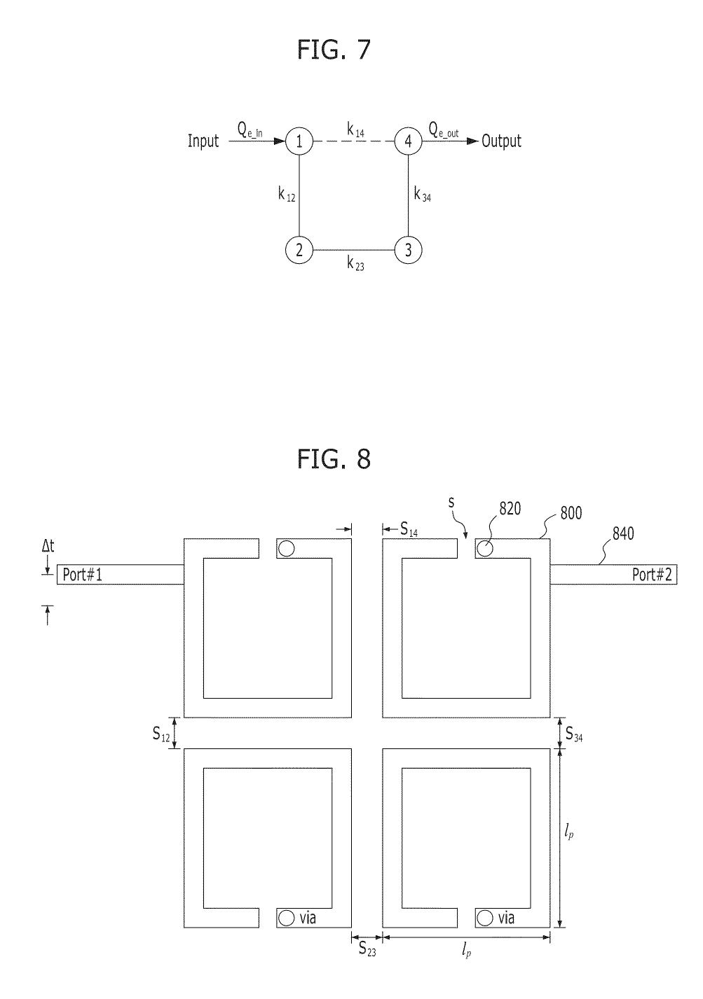

FIG. 7 is a diagram illustrating a resonator connection form of the ring resonator filter in accordance with the embodiment of the present invention.

Referring to FIG. 7, in designing the filter by consecutively connecting the plurality of resonators, that is, connecting the plurality of resonators with each other in cascade, a cascaded quadruplet (CQ) filter in 2×2 form as the smallest form may be formed. In this case, an interval between each resonator connected with each other in cascade may be set according to coupling coefficients k12, k23, k34, and k14 between each resonator.

FIG. 8 is a plan view of a ring resonator filter in accordance with another embodiment of the present invention.

Referring to FIG. 8, the filter having the ring resonator includes a plurality of ring resonators including a ring resonant unit 800 configured by the microstrip line and a via 820 connecting the resonant unit 800 with a ground surface (not illustrated), wherein the plurality of ring resonators may be connected with each other in cascade. An input of the filter may be referred to as port 1 (Port #1) and an output of the filter may be referred to as port 2 (Port #2). In this case, a part of the resonant unit 800 may have a opened (s) form. The embodiment of the present invention may have a size 75% smaller than that of the resonator configured only by the ring microstrip line. In this case, as an example of values for simulation, the central frequency may be set to be 2.164 GHz, a fractional bandwidth (FBW) may be set to be 0.04, external quality factor Qe may be set to be 23.24, Δt may be set to be 1.266 mm, S12=S34 may be set to be 0.791 mm, S23 may be set to be 1.012 mm, and S14 may be set to be 0.964 mm Here, the values set as S12, S34, S23, and S14 are an interval between the resonators and may be set to have values equal to the components of the following coupling matrix.

$$[ {m}_{ij} ] = [ \begin{matrix}0 & 0.8775 & 0 & - 0.2035 \\ 0.8775 & 0 & 0.7894 & 0 \\ 0 & 0.7894 & 0 & 0.8775 \\ - 0.2035 & 0 & 0.8775 & 0\end{matrix} ] , {R}_{i n} = {R}_{out} = 1.0757$$

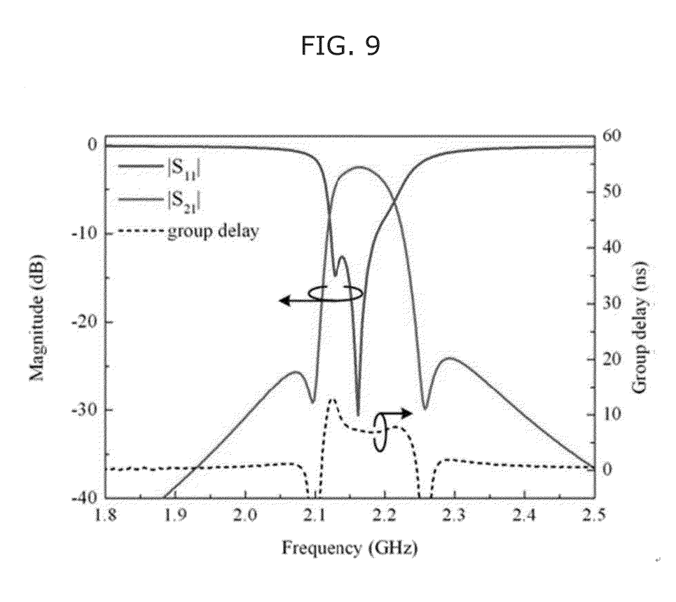

FIG. 9 is a diagram illustrating a frequency response of a ring resonator filter in accordance with another embodiment of the present invention.

Referring to FIG. 9, a portion represented by a group of arrows represents whether three graphs are analyzed based on any of the parameters differently marked at the left and right, respectively, when reading the three graphs. In this case, depending on the exemplified values set in FIG. 8, insertion loss is 2.50 dB and the return loss is 26.90 dB, at the central frequency of 2.164 GHz and a change in a group delay within a bandwidth of 60 MHz is 3.64 ns or less.

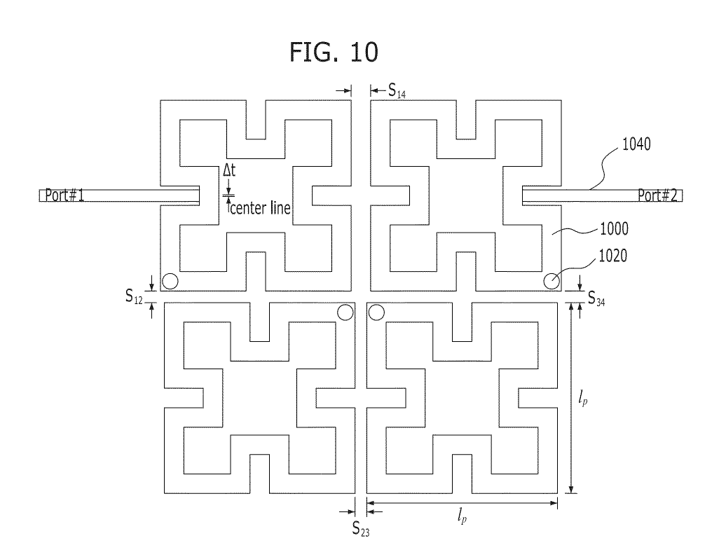

FIG. 10 is a plan view of the ring resonator filter in accordance with the embodiment of the present invention.

Referring to FIG. 10, the filter having the ring resonator includes a plurality of ring resonators including a ring resonant unit 1000 configured by the microstrip line and a via 1020 connecting a resonant unit 1000 with a ground surface (not illustrated), wherein the plurality of ring resonators may be connected with each other in cascade. An input of the filter may be referred to as port 1 (Port #1) and an output of the filter may be referred to as port (Port #2). In this case, the resonant unit 1000 may be formed to have a structure folded toward the inside of the ring while maintaining the ring The embodiment of the present invention may have a size 57.8% smaller than that of the resonator configured only by the ring microstrip line. In this case, as an example of values for simulation, the central frequency may be set to be 2.120 GHz, the fractional bandwidth (FBW) may be set to be 0.05, the external quality factor Qe may be set to be 23.24, Δt may be set to be 0.229 mm, S12=S34 may be set to be 0.581 mm, S23 may be set to be 0.628 mm, and S14 may be set to be 0.649 mm. Here, the values set as S12, S34, S23, and S14 are an interval between the resonators and may be set to have values equal to the components of the following coupling matrix.

$$[ {m}_{ij} ] = [ \begin{matrix}0 & 0.8775 & 0 & - 0.2035 \\ 0.8775 & 0 & 0.7894 & 0 \\ 0 & 0.7894 & 0 & 0.8775 \\ - 0.2035 & 0 & 0.8775 & 0\end{matrix} ] , {R}_{i n} = {R}_{out} = 1.0757$$

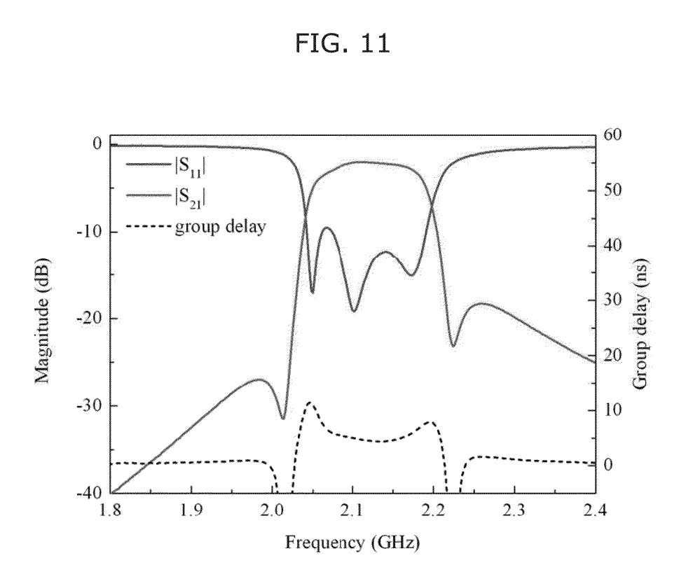

FIG. 11 is a diagram illustrating the frequency response of the ring resonator filter in accordance with the embodiment of the present invention.

Referring to FIG. 11, the graph marked by the group delay may be analyzed based on a right parameter and the remaining graphs may be analyzed based on a left parameter. In this case, depending on the exemplified values set in FIG. 10, the insertion loss is 2.08 dB and the return loss is 14.40 dB, at the central frequency of 2.120 GHz and the change in the group delay within a bandwidth is 1.550 ns or less.

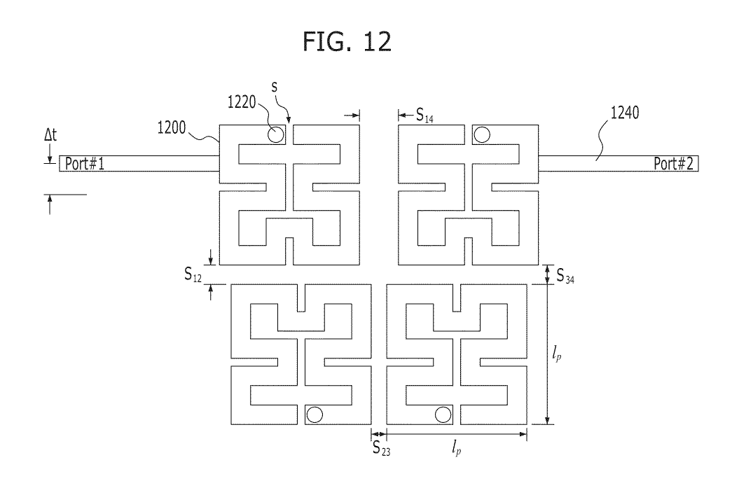

FIG. 12 is a plan view of a ring resonator filter in accordance with another embodiment of the present invention.

Referring to FIG. 12, the filter having the ring resonator includes a plurality of ring resonators including a ring resonant unit 1200 configured by the microstrip line and a via 1220 connecting a resonant unit 1200 with a ground surface (not illustrated), wherein the plurality of ring resonators may be connected with each other in cascade. An input of the filter may be referred to as port 1 (Port #1) and an output of the filter may be referred to as port 2 (Port #2). In this case, the resonant unit 1200 may be formed to have a form in which a part of the microstrip line is opened (s) and may be formed to have a folded structure toward the inside thereof. When comparing with the resonator illustrated in FIG. 2, the resonator in accordance with the embodiment of the present invention may be formed to have a length reduced by about 13.3% and the size of the filter formed by connecting the four resonators with each other in cascade in accordance with the embodiment of the present invention may be formed to have a size reduced by about 25% when comparing the filter illustrated in FIG. 8. That is, the resonator in accordance with the embodiment of the present invention may be formed to have a size reduced by 56.65% (based on a length) and 81.25% (based on an area), respectively, when comparing the resonator configured only by the ring microstrip line with the filter. In this case, as an example of values for simulation, the central frequency may be set to be 2.165 GHz, the fractional bandwidth (FBW) may be set to be 0.04, the external quality factor Qe may be set to be 23.24, Δt may be set to be 0.732 mm, S12=S34 may be set to be 0.567 mm, S23 may be set to be 0.385 mm, and S14 may be set to be 0.918 mm. Here, the values set as S12, S34, S23, and S14 are an interval between the resonators and may be set to have values equal to the components of the following coupling matrix.

$$[ {m}_{ij} ] = [ \begin{matrix}0 & 0.8775 & 0 & - 0.2035 \\ 0.8775 & 0 & 0.7894 & 0 \\ 0 & 0.7894 & 0 & 0.8775 \\ - 0.2035 & 0 & 0.8775 & 0\end{matrix} ] , {R}_{i n} = {R}_{out} = 1.0757$$

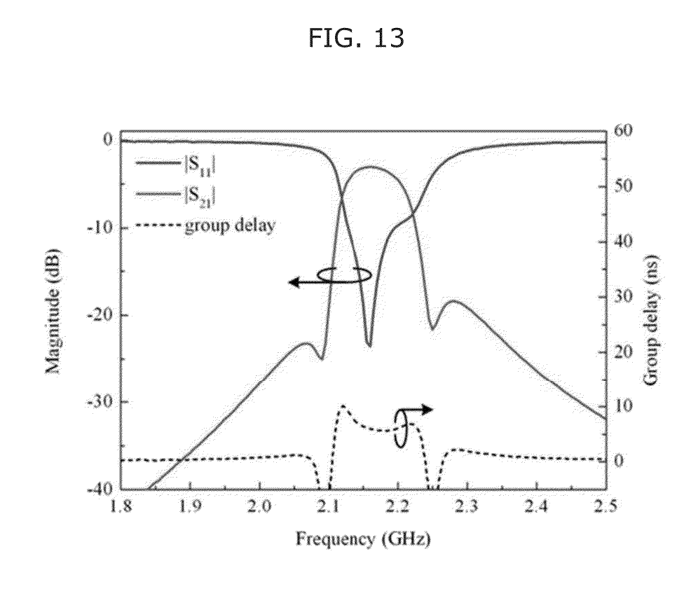

FIG. 13 is a diagram illustrating a frequency response of the ring resonator filter in accordance with another embodiment of the present invention.

Referring to FIG. 13, a portion represented by a group of arrows represents whether three graphs are analyzed based on any of the parameters differently marked at the left and right, respectively, when reading the three graphs. In this case, depending on the exemplified values set in FIG. 12, insertion loss is 3.10 dB and the return loss is 19.60 dB, at the central frequency of 2.165 GHz and the change in the group delay within the bandwidth of 60 MHz is 2.15 ns or less.

In accordance with the embodiment of the present invention as described above, the smaller and cheaper resonator and the filter having the same can be provided by reducing the resonance mode frequency using the ring resonator configured by the microstrip line including the via and the filter having the same.

The present invention will be apparent to those skilled in the art that substitutions, modifications and variations can be made without departing from the spirit and scope of the invention and therefore, is not limited to the aforementioned embodiments and the accompanying drawings.

What is claimed is:

1. A ring resonator, comprising:
a ring resonant unit configured by a microstrip line; and
a via connecting the resonant unit with a ground surface.

2. The ring resonator of claim 1, wherein the resonant unit has a partially opened form.

3. The ring resonator of claim 2, wherein the resonant unit is formed to a structure folded toward an inside.

4. The ring resonator of claim 1, wherein the resonant unit is formed to a structure folded toward an inside.

5. A ring resonator filter, comprising:
a plurality of ring resonators including a ring resonant unit configured by a microstrip line; and a via connecting the resonant unit with a ground surface,
wherein the plurality of ring resonators are connected with each other in cascade.

6. The ring resonator filter of claim 5, wherein the resonant unit has a partially opened form.

7. The ring resonator filter of claim 6, wherein the resonant unit is formed to a structure folded toward an inside.

8. The ring resonator filter of claim 5, wherein the resonant unit is formed to a structure folded toward an inside.
